(19) United States
(12) Patent Application Publication
(10) Pub. No.: US 2025/0224988 A1
(43) Pub. Date: Jul. 10, 2025

(54) INFORMATION PROCESSING METHOD, PROGRAM, AND LEARNING METHOD

(71) Applicant: Sony Group Corporation, Tokyo (JP)

(72) Inventor: Shoichi AWAI, Tokyo (JP)

(73) Assignee: Sony Group Corporation, Tokyo (JP)

(21) Appl. No.: 18/846,677

(22) PCT Filed: Mar. 16, 2023
(86) PCT No.: PCT/JP2023/010421

§ 371 Date: Sep. 13, 2024

(30) Foreign Application Priority Data
Mar. 24, 2022 (JP) 2022-047932

(51) Int. Cl. G06F 9/50

(52) U.S. Cl. CPC G06F 9/5027

(57) ABSTRACT

An information processing method is an information processing method to be executed by an information processing device. The method includes performing optimization of a layout address of subroutines in an executable body including a plurality of subroutines, based on a learning result obtained by machine learning.

### FIELD

The present disclosure relates to an information processing method, a program, and a learning method.

### BACKGROUND

There is known a conventional technology related to an executable body such as a program to be executed by a computer, specifically, a technology of optimizing the executable body by analyzing a source code of the executable body (refer to Patent Literature 1, for example).

### CITATION LIST

### Patent Literature

Patent Literature 1: JP 2018-156654 A

### SUMMARY

### Technical Problem

However, in the above-described known technology, there is room for further improvement in optimizing the executable body to be executed by a computer without changing the source code.

For example, the above-described conventional technology is intended to achieve optimization at a source code level. This makes it necessary to change the source code in optimizing the executable body according to the result of the analysis on the source code.

Meanwhile, in recent years, a processing speed of a central processing unit (CPU) of a computer is known to have been improved at several tens % per year. On the other hand, the improvement in the processing speed of main memory of the computer is known to be low in typical cases.

Based on this fact, the processing speed of the entire system is bottlenecked by the speed of the main memory in a large-scale programming model on the assumption that the cost of access to the main memory is constant.

A computer includes cache memory that bridges such a speed difference between the CPU and the main memory, but the cache memory has a small capacity. For this reason, a long wait time (generally several hundred clocks) is to be inserted in the access to the main memory, making it difficult to sufficiently utilizing high-speed CPU resources.

Therefore, in order to achieve a faster operation of the executable body, how the executable body in execution continues to achieve a hit with the cache memory will be important. However, there are currently many technical difficulties in order to perform optimization at such a level.

In view of this, the present disclosure proposes an information processing method, a program, and a learning method, capable of optimizing an executable body to be executed by a computer without changing a source code.

### Solution to Problem

In order to solve the above problems, one aspect of an information processing method according to the present disclosure is an information processing method to be executed by an information processing device. The method includes performing optimization of a layout address of subroutines in an executable body including a plurality of subroutines, based on a learning result obtained by machine learning.

### BRIEF DESCRIPTION OF DRAWINGS

FIG. 1 is a flowchart illustrating an example of a processing procedure of a typical executable body.

FIG. 2 is a diagram (part 1) illustrating layout examples of the executable body of FIG. 1 in main memory and cache memory.

FIG. 3 is a diagram (part 2) illustrating layout examples of the executable body of FIG. 1 in main memory and cache memory.

FIG. 4 is a schematic diagram of an information processing method according to an embodiment of the present disclosure.

FIG. 5 is a diagram illustrating a concept image of an execution instruction address and a cache hit in an executable body before optimization.

FIG. 6 is a diagram illustrating a concept image of an execution instruction address and a cache hit in an executable body after optimization.

FIG. 7 is a block diagram illustrating a configuration example of an information processing device according to the embodiment of the present disclosure.

FIG. 8 is a diagram illustrating an example of a trace image generated by execution of an executable body before optimization.

FIG. 9 is a diagram illustrating an example of a trace image generated by execution of an executable body after optimization.

FIG. 10 is a flowchart illustrating a processing procedure executed by the information processing device.

FIG. 11 is a diagram illustrating a modification.

FIG. 12 is a hardware configuration diagram illustrating an example of a computer that implements functions of the information processing device.

### DESCRIPTION OF EMBODIMENTS

Embodiments of the present disclosure will be described below in detail with reference to the drawings. Note that, in each of the following embodiments, the same parts are denoted by the same reference symbols, and a repetitive description thereof will be omitted.

Hereinafter, in order to distinguish from the program according to the embodiment of the present disclosure, a program generated in the information processing according to the embodiment of the present disclosure is described as an “executable body”. The “executable body” is a software binary file that can be read, interpreted, and executed by a processor such as a CPU. The “executable body” widely includes various software binary forms such as a file indicating that the file is in an executable body form or is a shared library by an extension and a file indicating that the file is in an executable body form by metadata such as a file permission bit instead of the extension.

The present disclosure will be described in the following order.

1. Overview
1-1. Problem of main memory regarding access speed, and cache memory
1-2. Current software development methods
1-3. Increasing use of OSS
1-4. Overview of information processing method according to embodiment of present disclosure
2. Configuration of information processing device
3. Modifications
4. Hardware configuration
5. Conclusion

### «1. Overview»

### <1-1. Problem of Main Memory Regarding Access Speed, and Cache Memory>

As described above, in recent years, it is known that the processing speed of the CPU has been improved at several tens % per year. On the other hand, the improvement in the processing speed of main memory of the computer is known to be low in typical cases. The processing speed of the main memory is considered to increase by several % per year.

As a result, a gap in performance between the CPU and the main memory is expanding each year. For example, in a recent processor, a memory access penalty (cache miss) occurs at frequencies of nearly 200 times, the processing speed of an entire system is bottlenecked by the speed of the main memory in a large-scale programming model on the assumption that the cost of access to the main memory is constant.

A computer includes cache memory that bridges such a speed difference between the CPU and the main memory, but the cache memory has a small capacity. For example, in a typical server CPU in recent years, the primary cache has capacity around 64 KB, the secondary cache has capacity around 256 KB, and the tertiary cache has capacity around 2.5 MB, which are capacities 3 to 6 digits smaller as compared with tens to hundreds of GBs of capacity of the main memory.

For this reason, a long wait time of generally several hundred clocks is to be inserted in the access to the main memory, making it difficult to sufficiently utilizing high-speed CPU resources. Therefore, in order to achieve a faster operation of the executable body, how the executable body in execution continues to achieve a hit with the cache memory will be important. However, there are currently many technical difficulties in order to perform optimization at such a level.

### <1-2. Current Software Development Methods>

Meanwhile, current software development is performed using high-level languages, that is, human-readable programming is performed in almost all (99.9% or more) cases. Exceptionally, machine language is directly coded by assembler language in a limited manner only in a case of directly operating a hardware resource located in a low layer of a system configuration such as a CPU or a sensor.

Therefore, most of the debugging work is source code level debugging, and machine language level debugging is not often performed unless there is a special condition.

In addition, software optimization and the like regarding the source code described in a high-level language is just implemented as designation or selection of an optimization flag when the source code is converted into a machine language instruction by a compiler or a linker.

Accordingly, optimization or the like is rarely considered at the level of the address layout of the executable body. Needless to say, the optimization in large-scale programming would not be practical.

### <1-3. Increase in OSS Use>

On the other hand, the software in current computer systems has a trend of going toward one with a larger scale and higher functionality, and at the same time, there is a strong demand for reducing the development period. This leads to a demand for improvement of development efficiency and thus, open source software (OSS) is increasingly used as one of specific measures.

In particular, OSS is increasingly used with a high ratio in modules having an impact on the execution time length and power consumption of the CPU. In order to achieve a sustainable society, promoting higher speed of processing and reduced power consumption is becoming an important strategy, and thus, it is important to provide a method of executing a module that uses OSS with high efficiency and low power consumption.

However, using a typical large-scale OSS with understanding its internal structure is relatively rare, and a user often uses OSS simply as a subroutine call according to a specification of an application programming interface (API) of OSS. In this case, optimization of OSS is often limited to designation of a compilation option or configuration setting according to the API. In order to understand the implementation of the OSS at the source code level and perform improvement such as achieving higher speed and lower power consumption, the understanding of the internal structure of OSS is inevitable, and this improvement is considered to involve many technical difficulties.

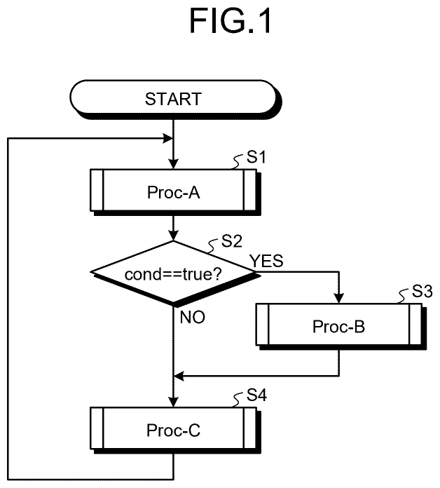

FIG. 1 is a flowchart illustrating an example of a processing procedure of a typical executable body. In the example of FIG. 1, subroutine Proc-A is called at the start of the processing (Step S1), and conditional branching is performed according to the execution result (Step S2).

When the condition is true (Step $2, Yes), subroutine Proc-B is executed (Step S3), and then subroutine Proc-C is executed (Step S4). When it is false (Step S2, No), execution of subroutine Proc-B is skipped and subroutine Proc-C is executed (Step S4). The procedure iterates the processing from Step S1.

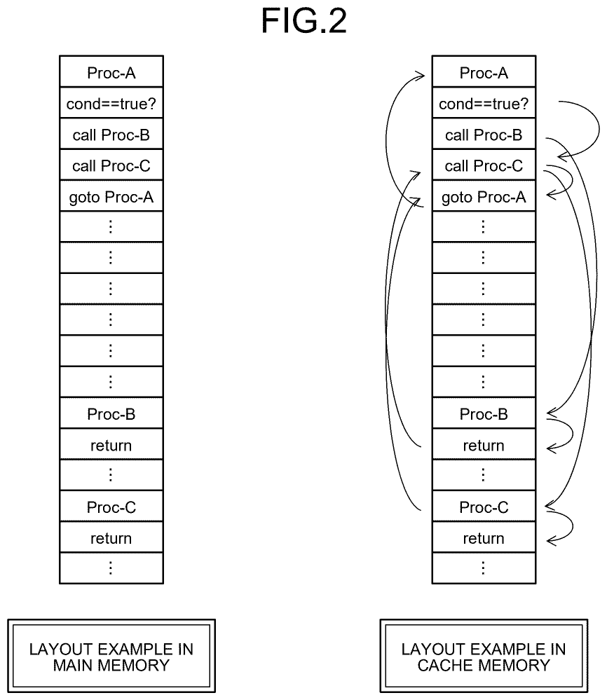

FIG. 2 is a diagram (part 1) illustrating layout examples of the executable body of FIG. 1 in main memory and cache memory. The example of FIG. 2 is an example in which all the instructions allocated in the main memory fit within the capacity of the cache memory including fitting within the cache memory even with the jump to the layout address of each of subroutines Proc-A, Proc-B, and Proc-C.

That is, subroutines Proc-A, Proc-B, and Proc-C can be considered to be efficiently linked in this example.

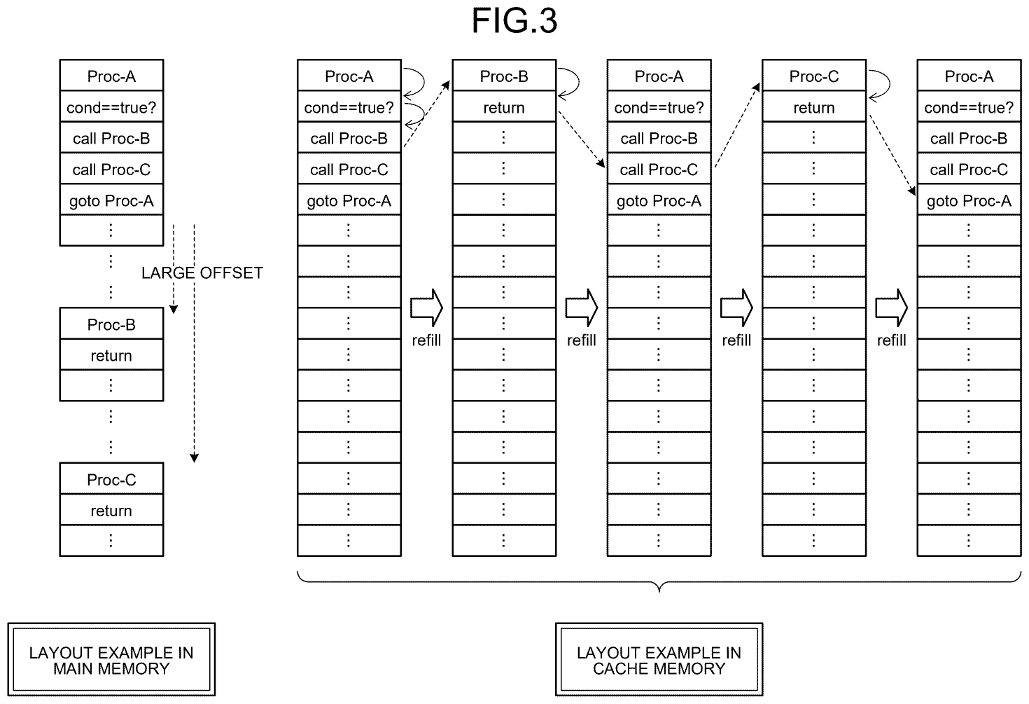

FIG. 3 is a diagram (part 2) illustrating layout examples of the executable body of FIG. 1 in main memory and cache memory. In the example of FIG. 3, in the executable body, subroutines Proc-A, Proc-B, and Proc-C are arranged with a large offset of address in the main memory.

In such a case, as illustrated in the same FIG. 3, subroutines Proc-A, Proc-B, and Proc-C cannot be stored in one unit of cache memory, and thus, cache refill is performed many times for each call of Proc-A, Proc-B, and Proc-C. Refill is to access the main memory to read an instruction and to relocate it to the cache memory because of the absence of the instruction to be called in the cache memory.

Repeated refill as illustrated in FIG. 3, that is, frequent occurrence of a cache miss has a negative impact on achieving higher processing speed and lower power consumption. However, as described above, there are currently many technical difficulties in promoting optimization at the level related to the address layout.

### 1-4. Overview of Information Processing Method According to Embodiment of Present Disclosure

In view of this, the information processing method according to the embodiment of the present disclosure optimizes the subroutine layout address in the executable body that includes a plurality of subroutines, based on a learning result obtained by machine learning.

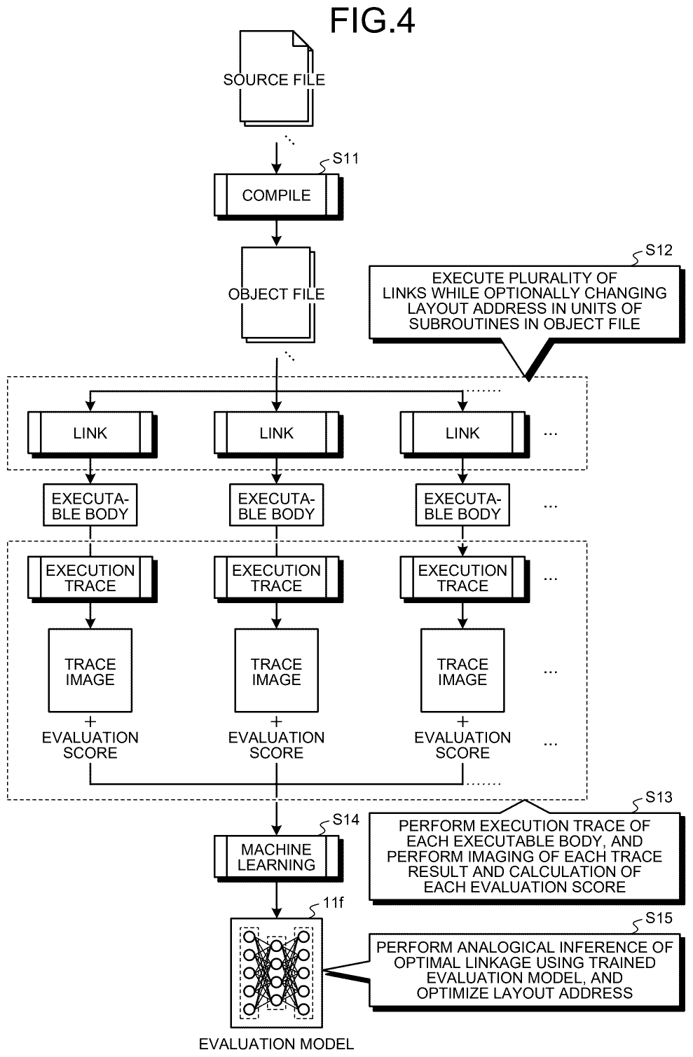

FIG. 4 is a schematic diagram of an information processing method according to the embodiment of the present disclosure. In the information processing method according to the embodiment of the present disclosure, the executable body is treated as a set of subroutines. In fact, every executable body with a large scale is practically a collection of a large number of subroutines, and thus, this step needs no particular operations.

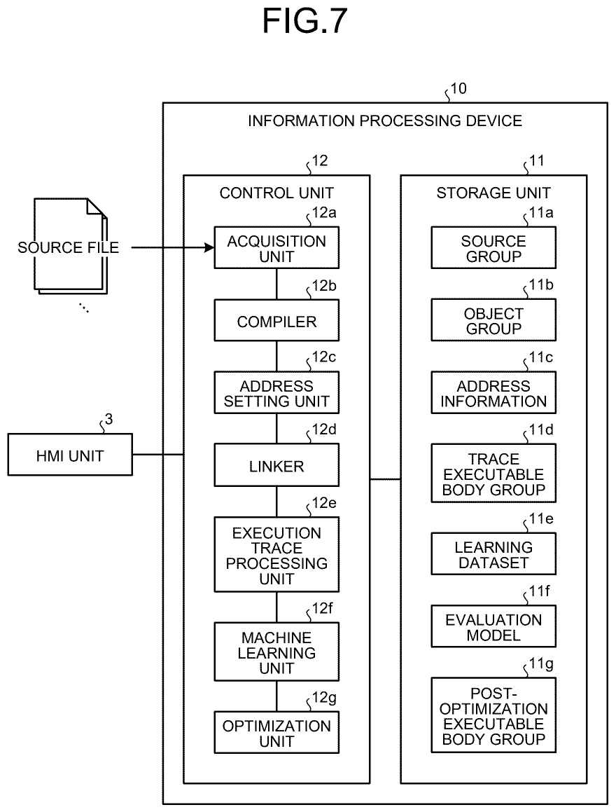

Specifically, as illustrated in FIG. 4, in the information processing method according to the embodiment of the present disclosure, an information processing device 10 (refer to FIG. 7) first acquires a source file that has described a source code and executes compilation (Step S11) so as to generates relocatable object files.

The information processing device 10 next executes a plurality of links while optionally changing the layout address in units of subroutines in the object file (Step S12) so as to generate a plurality of executable bodies as a result of each link.

The designation of the location address is a function of a typical linker, but the designation of the layout address is usually not essential. When the layout address is not designated, the address designation can be done by automatic processing of the linker. Therefore, in many software developments, the layout address is not particularly designated in many cases.

Note that, in Step S12, the information processing device 10 records a pair of optionally designated layout address and a subroutine corresponding to the layout address on a one-to-one basis.

Subsequently, the information processing device 10 performs execution trace on each executable body generated in Step S12, and performs imaging of each trace result and calculation of each evaluation score (Step S13).

More specifically, the information processing device 10 actually executes the generated executable body, and traces and records addresses of instructions sequentially executed by the CPU at that time. At the same time, the information processing device 10 weights the address by the number of times of executions, and generates a trace image using color coding or the like.

For example, the information processing device 10 generates a trace image by assigning a value close to 1, which is the maximum value of color expressed in RGB, to an address with a large number of times of executions, and by assigning a value close to 0, which is the minimum value, to an address with a small number of times of executions. As described above, since the address and the subroutine are in one-to-one correspondence, the trace image can be regarded as an image having a color corresponding to the subroutine.

At the same time, in Step S13, the information processing device 10 measures the execution time length and the power consumption at the time of execution, and uses the measured information as evaluation scores for the trace images having the above-described colors. For example, the information processing device 10 calculates the evaluation score such that the shorter the execution time length, the larger the value will be. Furthermore, for example, the information processing device 10 calculates the evaluation score such that the lower the power consumption, the larger the value will be.

Subsequently, the information processing device 10 executes machine learning using the plurality of pairs of trace images and evaluation scores generated in Step S13 as a dataset (Step S14) so as to generate an evaluation model 11f that evaluates linkage states of the executable body, as a learning result. The information processing device 10 uses, a deep learning algorithm as a machine learning algorithm, for example.

Subsequently, the information processing device 10 performs analogical inference of an optimal linkage using the trained evaluation model 11f and optimizes the layout address (Step S15). That is, by using the evaluation model 11f, the information processing device 10 can perform analogical inference on which combination of layout addresses for generating trace images has a high evaluation score by using a concept of inverse operation. That is, the information processing device 10 can calculate what types of address layout of subroutine groups on address leads to high evaluation scores. A high evaluation score indicates one or both of a short execution time length (high processing speed) and low power consumption.

Note that data generated by a method such as color coding is image data, and thus includes two-dimensional information having vertical and horizontal information. At this time, the information processing device 10 performs alignment (adjustment) of the vertical and horizontal sizes based on the size of the cache memory, such as the primary cache, the secondary cache, and the tertiary cache included in the CPU, making it possible to analyze whether the address layout is optimal layout appropriate for each of the sizes of the primary cache, the secondary cache, and the tertiary cache.

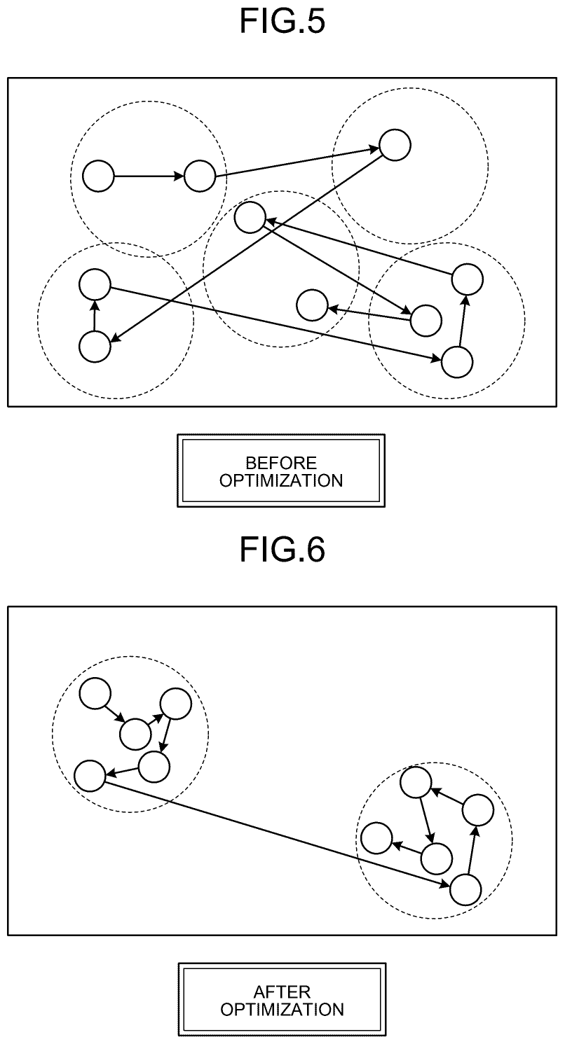

FIGS. 5 and 6 illustrate images of an execution instruction address and a cache hit in each executable body before and after optimization using the information processing method according to the embodiment of the present disclosure. FIG. 5 is a diagram illustrating a concept image of an execution instruction address and a cache hit in an executable body before optimization. FIG. 6 is a diagram illustrating a concept image of an execution instruction address and a cache hit in an executable body after optimization.

Rectangles in FIGS. 5 and 6 schematically represent the entire main memory. In addition, a closed curve of a broken line in the drawing schematically represents a size that fits in the cache memory. In addition, open circles in the drawing schematically represent each subroutine. Arrows in the drawing represent jumps between subroutines along the execution order of processing.

The example of the state before optimization in FIG. 5 includes five closed curves of a broken line, indicating that at least four cache refill operations have been performed during execution of ten subroutines along the execution order.

On the other hand, an example of the state after optimization in FIG. 6 includes two closed curves of a broken line, indicating that one cache refill operation has been performed during execution of ten subroutines along the execution order. That is, the example of FIG. 6 indicates that optimization of the layout address of the subroutine by the information processing according to the embodiment of the present disclosure makes it possible for the executable body being executed to continuously hit the cache memory as compared with the time before the optimization, and that the higher speed processing and low power consumption have been achieved.

In this manner, in the information processing method according to the embodiment of the present disclosure, the information processing device 10 optimizes the subroutine layout address in the executable body that includes a plurality of subroutines, based on a learning result obtained by machine learning.

Consequently, with the information processing method according to the embodiment of the present disclosure, it is possible to optimize the executable body to be executed by the computer without changing the source code.

Hereinafter, a configuration example of the information processing device 10 using the information processing method according to the embodiment of the present disclosure will be described more specifically.

### «2. Configuration of Information Processing Device»

FIG. 7 is a block diagram illustrating a configuration example of an information processing device 10 according to the embodiment of the present disclosure. Note that FIG. 7 illustrates only components necessary for describing features of the embodiment of the present disclosure, and omits description of ordinary components.

In other words, each of components illustrated in FIG. 7 is provided as a functional and conceptional illustration and thus does not necessarily need to be physically configured as illustrated. For example, the specific form of distribution/integration of each device is not limited to those depicted in the drawings, and all or a part thereof may be functionally or physically distributed or integrated into arbitrary units according to various loads and use conditions.

The description using FIG. 7 will simplify or omit a description of already described components.

As illustrated in FIG. 7, the information processing device 10 includes a storage unit 11, and a control unit 12. Furthermore, the information processing device 10 is connected to a Human Machine Interface (HMI) unit 3.

The HMI unit 3 is a component including an interface component for a human. The HMI unit 3 is implemented by a keyboard, a mouse, a display, a microphone, a speaker, and the like. The HMI unit 3 may include not only hardware components but also software components. The HMI unit 3 is operated by a person using the information processing device 10, such as a software developer.

The storage unit 11 is implemented by semiconductor memory elements such as random access memory (RAM), read only memory (ROM), and flash memory, or other storage devices such as a hard disk or an optical disc.

In the example illustrated in FIG. 7, the storage unit 11 stores a source group 11a, an object group 11b, address information 11c, a trace executable body group 11d, a learning dataset 11e, an evaluation model 11f, and a post-optimization executable body group 11g. In addition, the storage unit 11 includes the main memory described above.

The source group 11a is a source file group describing a source code for generating an executable body, acquired by the acquisition unit 12a to be described below. The object group 11b is a relocatable binary object group generated by compilation executed by a compiler 12b to be described below.

The address information 11c is information related to a pair of an optionally designated layout address and a subroutine corresponding to the layout address on a one-to-one basis, recorded in the above-described Step S12.

The trace executable body group 11d is an executable body group generated in Step S12 described above. The learning dataset 11e is a dataset including a plurality of pairs of the trace image generated in Step S13 described above and the evaluation score of the image.

As described above, the evaluation model 11f is generated as a learning result obtained by the machine learning in Step S14. The evaluation model 11f is a model that evaluates a linkage state of the executable body. The post-optimization executable body group 11g is an executable body group in which the layout address of the subroutine is optimized, generated by the optimization unit 12g to be described below.

The control unit 12 is a controller, and is implemented by execution of a program according to the embodiment of the present disclosure (not illustrated) stored in the storage unit 11 by a CPU, a micro processing unit (MPU), or the like using the RAM as a work area. Furthermore, the control unit 12 can be implemented by, for example, an integrated circuit such as an application specific integrated circuit (ASIC) or a field programmable gate array (FPGA).

The control unit 12 includes an acquisition unit 12a, a compiler 12b, an address setting unit 12c, a linker 12d, an execution trace processing unit 12e, a machine learning unit 12f, and an optimization unit 12g, and implements or executes functions and actions of information processing described below.

The acquisition unit 12a acquires a source file describing the source code and stores the acquired source file in the source group 11a. The acquisition unit 12a may acquire, via a network, the source file from another device connected to the information processing device 10 via a network, or may acquire the source file from a computer-readable recording medium. The acquisition unit 12a may acquire the source file generated by the coding work through the HMI unit 3.

The compiler 12b executes the compilation in Step S11 described above based on the source group 11a, and stores the generated relocatable binary object in the object group 11b.

In Step S12 described above, the address setting unit 12c sets the layout address in units of subroutines designated for the linker 12d. The address setting unit 12c repeatedly sets such setting while optionally changing the layout address.

The address setting unit 12c may set the layout address while changing the layout address according to an optionally selected value manually input via the HMI unit 3, or may set the layout address while changing the layout address using a random value automatically input according to a description of a shell script or the like. The present embodiment performs setting, in any case, by optionally changing the layout address.

Every time the layout address is set by the address setting unit 12c, the linker 12d executes the link in Step S12 described above based on the object group 11b and the set layout address. In addition, the linker 12d stores each executable body generated by executing the link in the trace executable body group 11d.

The execution trace processing unit 12e executes Step S13 described above. That is, the execution trace processing unit 12e performs execution trace on each executable body of the trace executable body group 11d to image a trace result for each executable body, and calculates an evaluation score for each executable body.

The execution trace processing unit 12e traces and records addresses of instructions sequentially executed by the CPU during execution of the executable body regarding imaging of the trace result, that is, generation of a trace image. At the same time, the execution trace processing unit 12e weights the address by the number of times of executions, and generates a trace image using color coding or the like.

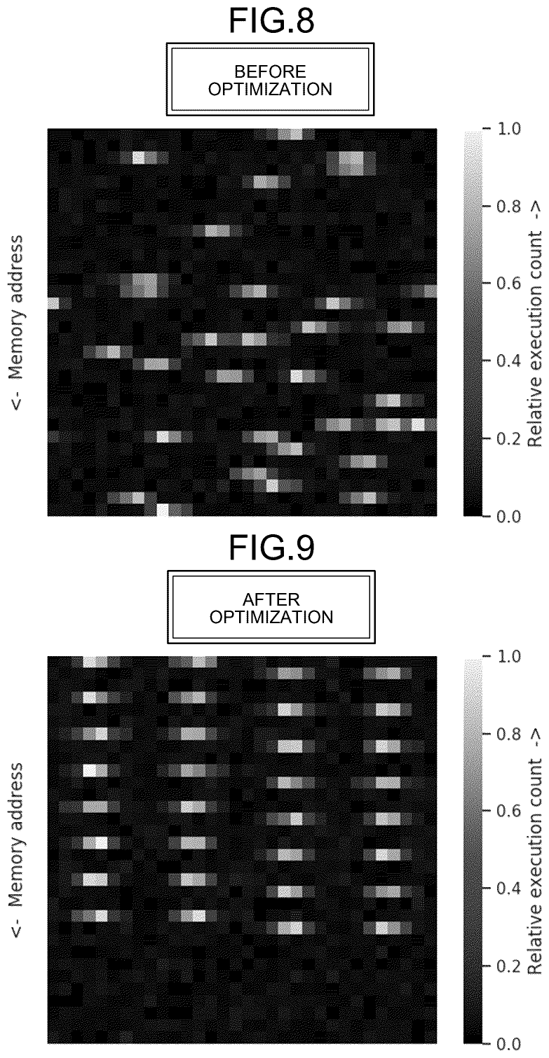

FIGS. 8 and 9 illustrate examples of trace images generated by execution of the executable body before and after optimization. FIG. 8 is a diagram illustrating an example of a trace image generated by execution of an executable body before optimization. FIG. 9 is a diagram illustrating an example of a trace image generated by execution of an executable body after optimization.

As illustrated in FIGS. 8 and 9, the execution trace processing unit 12e generates a trace image as a heatmap indicating changes in luminance according to the number of times of instructions executed for the memory address. As illustrated in FIGS. 8 and 9, the memory address is mapped so as to increase in the lower direction of the vertical side (vertical axis) of the image while folding back along the length of the horizontal side (horizontal axis) of the image.

The luminance is a relative value, in which 1.0 (direction toward white) indicates the largest number of times of executions, and on the contrary, 0.0 (black) indicates the smallest number of times of executions. Each band-shaped cluster whose luminance changes corresponds to each subroutine.

As illustrated in FIG. 8, in the trace image before optimization, each subroutine is observed to be located so as to be randomly scattered in the entire memory space, for example. In contrast, as illustrated in FIG. 9, in the optimized trace image, each subroutine is observed to be located so as to be aligned in the memory space, for example. When comparing FIGS. 8 and 9, it is obvious that the number of times of cache refill is smaller in FIG. 9.

Therefore, the optimization unit 12g to be described below performs analogical inference on the optimal layout address of each subroutine using the evaluation model 11f and relocates the addresses so as to achieve an address layout at which an image is generated as illustrated in FIG. 9, for example.

Although FIGS. 8 and 9 illustrate an example in which the trace image is a square, the length of the side of the image is not limited. The size of the image may under alignment based on the size of the cache memory, such as the primary cache, the secondary cache, or the tertiary cache. For example, the size of the image undergoes alignment so as to be a size corresponding to “data structure alignment” such as an integral multiple of the size of the cache memory or a power of two. This makes it possible to analyze whether the address layout is an optimal layout appropriate for the size of each cache memory.

Returning to the description of FIG. 7. Regarding the calculation of the evaluation score, the execution trace processing unit 12e measures the execution time length and the power consumption at the time of execution of the executable body as described above, and uses the result as the evaluation score for the trace image. In addition, the execution trace processing unit 12e stores a set of pairs of the trace image and the evaluation score generated by executing and tracing each executable body in the learning dataset 11e.

The machine learning unit 12f executes the machine learning in Step S14 described above based on the learning dataset 11e and generates the evaluation model 11f.

The optimization unit 12g performs analogical inference of the optimum linkage using the evaluation model 11f and optimizes the layout address (Step S15 described above). That is, by using the evaluation model 11f, the optimization unit 12g performs analogical inference on which combination of layout addresses for generating trace images has a high evaluation score by using a concept of inverse operation. The optimization unit 12g performs analogical inference of a combination of layout addresses of individual subroutines that generate a trace image as illustrated in FIG. 9, for example.

Subsequently, the optimization unit 12g causes the address setting unit 12c to set the layout address obtained by analogical inference. In addition, the optimization unit 12g causes the linker 12d to execute the link with designation of the layout address set by the address setting unit 12c. The linker 12d executes the link in response, and stores the generated executable body in the post-optimization executable body group 11g.

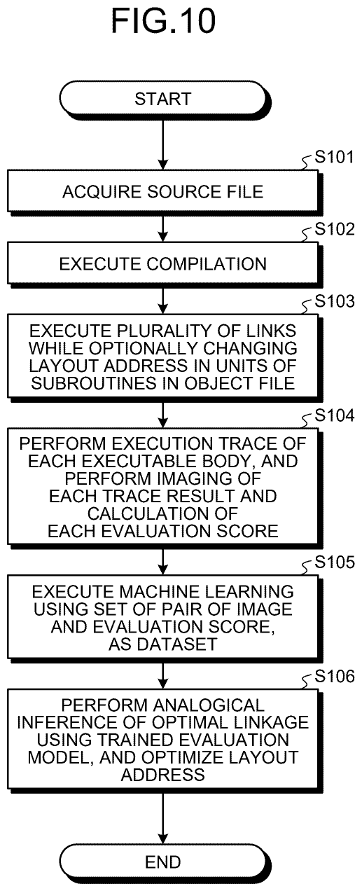

Next, a processing procedure executed by the information processing device 10 will be described with reference to FIG. 10. FIG. 10 is a flowchart illustrating a processing procedure executed by the information processing device 10.

As illustrated in FIG. 10, first, the acquisition unit 12a acquires the source file (Step S101).

Subsequently, the compiler 12b executes compilation (Step S102).

Subsequently, the linker 12d executes a plurality of links while optionally changing the layout address in units of subroutines in the object file (Step S103). Subsequently, the execution trace processing unit 12e executes trace on each executable body, and performs imaging of each trace result and calculation of each evaluation score (Step S104).

Subsequently, the machine learning unit 12f executes machine learning using a set of pairs of images and evaluation scores as a dataset (Step S105).

Subsequently, the optimization unit 12g performs analogical inference of an optimal linkage using the trained evaluation model 11f and optimizes the layout address (Step S106). This ends the processing.

### «3. Modifications»

The embodiment of the present disclosure described above can be provided with several modifications.

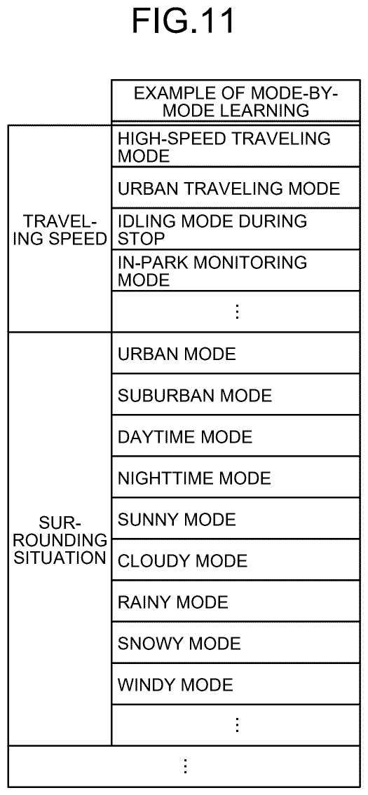

FIG. 11 is a diagram illustrating a modification. Here is an assumable case where the optimized executable body generated by the information processing device 10 is installed in the in-vehicle system.

In the case of an in-vehicle system, as illustrated in FIG. 11, there are concepts of various modes. As illustrated in the figure, from the viewpoint of the traveling speed, there are various modes such as a high-speed traveling mode, an urban traveling mode, an idling mode during stop, and an in-park monitoring mode. The high-speed traveling mode is, for example, a

mode when the traveling speed is 60 km/h or more. The urban driving mode is, for example, a mode when the traveling speed is less than 60 km/h. The idling mode during stop is a mode when the vehicle is stopped and idling. The in-park monitoring mode is a mode when the vehicle is parked for monitoring using a vehicle power supply.

In addition, as illustrated in the figure, from the viewpoint of the surrounding situation, there are various modes such as an urban mode, a suburban mode, a daytime mode, a nighttime mode, a sunny mode, a cloudy mode, a rainy mode, a snowy mode, and a windy mode.

The urban mode is a mode in which there are many objects to be recognized in the surroundings, the relative speed with respect to the vehicle body is high, and the frequency of switching of existing objects is high. The suburban mode is a mode in which the number of objects to be recognized is relatively small, the distance is long, and the number of times of change of the objects is small.

The daytime mode, the nighttime mode, the sunny mode, the cloudy mode, the rainy mode, the snowy mode, and the windy mode are modes of the daytime, the nighttime, the sunny time, the cloudy time, the rainy time, the snowy time, and the windy time, respectively.

There is a high possibility that various modules (executable bodies) that are installed in the in-vehicle system and execute various types of processing such as sensor detection, image recognition, situation understanding, route planning, and vehicle body control, have mutually different execution frequencies and execution patterns for these modes.

For example, the high-speed traveling mode all the modules are called and executed, and thus is considered to need a highest processing load on the module for situation understanding among the modules.

On the other hand, in the in-parking monitoring mode, sensor detection and image recognition are executed at a low rate, while route planning, vehicle body control, and the like are considered to be hardly executed.

Therefore, the information processing device 10 executes mode-by-mode learning in which machine learning is performed for the layout address of the subroutine for each of these modes, and executes mode-by-mode optimization of each module to be installed in the in-vehicle system based on a learning result obtained by the machine learning, making it possible to achieve higher processing speed and low power consumption for each mode in the in-vehicle system.

Furthermore, although the embodiment of the present disclosure has described an example of using deep learning as a machine learning algorithm, the machine learning algorithm is not limited. Therefore, the machine learning algorithm may include an algorithm derived from deep learning or another algorithm, other than deep learning.

Furthermore, among individual processing described in the above embodiments of the present disclosure, all or a part of the processing described as being performed automatically may be manually performed, or the processing described as being performed manually can be performed automatically by known methods. In addition, the processing procedures, specific names, and information including various data and parameters depicted in the above specifications or drawings can be changed in any manner unless otherwise specified. For example, a variety of information illustrated in each of the drawings are not limited to the information illustrated.

In addition, each of components of each device is provided as a functional and conceptional illustration and thus does not necessarily need to be physically configured as illustrated. That is, the specific form of distribution/integration of each of the devices is not limited to those illustrated in the drawings, and all or a part thereof may be functionally or physically distributed or integrated into arbitrary units according to various loads and use situations.

For example, by removing the optimization unit 12g and the post-optimization executable body group 11g from the components of the information processing device 10 illustrated in FIG. 7, the information processing device 10 can be configured as a learning device.

Furthermore, the above-described embodiments of the present disclosure can be appropriately combined within a range implementable without contradiction of processing.

Furthermore, the order of individual steps illustrated in the sequence diagram or the flowchart of the present embodiment can be changed as appropriate.

«4. Hardware configuration»

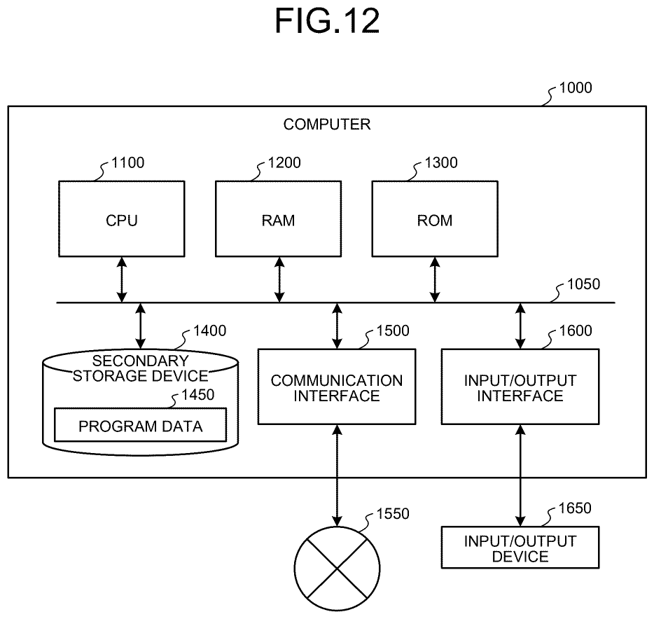

The information processing device 10 according to the above-described embodiment of the present disclosure is implemented by a computer 1000 having a configuration as illustrated in FIG. 12, for example. FIG. 12 is a hardware configuration diagram illustrating an example of the computer 1000 that implements functions of the information processing device 10. The computer 1000 includes a CPU 1100, RAM 1200, ROM 1300, a secondary storage device 1400, a communication interface 1500, and an input/output interface 1600. Individual components of the computer 1000 are interconnected by a bus 1050.

The CPU 1100 operates based on a program stored in the ROM 1300 or the secondary storage device 1400, and controls individual components. For example, the CPU 1100 develops a program stored in the ROM 1300 or the secondary storage device 1400 to the RAM 1200, and executes processes corresponding to various programs.

The ROM 1300 stores a boot program such as a basic input output system (BIOS) executed by the CPU 1100 when the computer 1000 starts up, a program dependent on hardware of the computer 1000, or the like.

The secondary storage device 1400 is a non-transitory computer-readable recording medium that records a program executed by the CPU 1100, data used by the program, or the like. Specifically, the secondary storage device 1400 is a recording medium that records a program according to the embodiment of the present disclosure, which is an example of program data 1450.

The communication interface 1500 is an interface for connecting the computer 1000 to an external network 1550. For example, the CPU 1100 receives data from other devices or transmits data generated by the CPU 1100 to other devices via the communication interface 1500. The input/output interface 1600 is an interface

for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the information processing device 10 according to the embodiment of the present disclosure, the CPU 1100 of the computer 1000 executes the program loaded on the RAM 1200 so as to implement the functions of the control unit 12 and the like. In addition, the secondary storage device 1400 stores a program according to the present disclosure and data in the storage unit 11. While the CPU 1100 executes the program data 1450 read from the secondary storage device 1400, the CPU 1100 may acquire these programs from another device via the external network 1550, as another example.

### «5. Conclusion»

As described above, according to an embodiment of the present disclosure, there is provided an information processing method to be executed by the information processing device 10, the method including optimizing a layout address of a subroutine in an executable body including a plurality of subroutines based on a learning result obtained by machine learning. This makes it possible to optimize the executable body to be executed by the computer, without changing the source code.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technique can also have the following configurations.

(1)

An information processing method to be executed by an information processing device, the method comprising
performing optimization of a layout address of subroutines in an executable body including a plurality of subroutines, based on a learning result obtained by machine learning.
   (2)

The information processing method according to (1), further comprising
generating a pair of an image and an evaluation score for the image, the image having been obtained by imaging the layout address based on number of times of executions on the layout address at the time of execution of the executable body, and performing the machine learning using a plurality of the pairs as a dataset,
wherein the optimization includes
optimizing the layout address using the learning result obtained by performing the machine learning.
   (3)

The information processing method according to (2), further comprising
performing execution of trace processing at a time of execution of the executable body including generation of the pair,
wherein the execution of trace processing includes
calculation of the evaluation score based on an execution time length or power consumption of the executable body.
   (4)

The information processing method according to (3),
wherein the execution of trace processing includes
calculation of the evaluation score such that the shorter the execution time length, the larger the value will be.
   (5)

The information processing method according to (3) or (4),
wherein the execution of trace processing includes calculation of the evaluation score such that the lower the power consumption, the larger the value will be.
   (6)

The information processing method according to (3), (4), or (5),
wherein the execution of trace processing includes
adjustment of a size of the image based on a size of cache memory included in the information processing device.
   (7)

The information processing method according to any one of (3) to (6),
wherein the execution of trace processing includes
generation of the image as a heatmap that changes in luminance according to number of times of instructions executed for an address of main memory included in the information processing device.
   (8)

The information processing method according to any one of (1) to (7),
wherein the optimization includes
optimizing the layout address for each system or each mode in which the executable body is executed.
   (9)

A program causing a computer to implement
performing optimization of a layout address of a subroutine in an executable body including a plurality of subroutines, based on a learning result obtained by machine learning.
   (10)

A learning method to be executed by a learning device, the learning method comprising:
executing a link of a plurality of execution bodies, each of the executable bodies including a plurality of subroutines, the execution of the link performed while optionally changing a layout address of the subroutine in the executable body; and
executing each of the plurality of execution bodies generated by executing the link, generating a pair of an image and an evaluation score for the image, the image having been obtained by imaging the layout address based on number of times of executions on the layout address at a time of execution, and performing machine learning using a plurality of the pairs as a dataset.

### REFERENCE SIGNS LIST

10 INFORMATION PROCESSING DEVICE
11 STORAGE UNIT
11a SOURCE GROUP
11b OBJECT GROUP
11c ADDRESS INFORMATION
11d TRACE EXECUTABLE BODY GROUP
11e LEARNING DATASET
11f EVALUATION MODEL
11g POST-OPTIMIZATION EXECUTABLE BODY GROUP
12 CONTROL UNIT
12a ACQUISITION UNIT
12b COMPILER
12c ADDRESS SETTING UNIT
12d LINKER
12e EXECUTION TRACE PROCESSING UNIT
12f MACHINE LEARNING UNIT
12g OPTIMIZATION UNIT

1. An information processing method to be executed by an information processing device, the method comprising
performing optimization of a layout address of subroutines in an executable body including a plurality of subroutines, based on a learning result obtained by machine learning.

2. The information processing method according to claim 1, further comprising
generating a pair of an image and an evaluation score for the image, the image having been obtained by imaging the layout address based on number of times of executions on the layout address at the time of execution of the executable body, and performing the machine learning using a plurality of the pairs as a dataset,
wherein the optimization includes
optimizing the layout address using the learning result obtained by performing the machine learning.

3. The information processing method according to claim 2, further comprising
performing execution of trace processing at a time of execution of the executable body including generation of the pair,
wherein the execution of trace processing includes
calculation of the evaluation score based on an execution time length or power consumption of the executable body.

4. The information processing method according to claim 3,
wherein the execution of trace processing includes
calculation of the evaluation score such that the shorter the execution time length, the larger the value will be.

5. The information processing method according to claim 3,
wherein the execution of trace processing includes
calculation of the evaluation score such that the lower the power consumption, the larger the value will be.

6. The information processing method according to claim 3,
wherein the execution of trace processing includes
adjustment of a size of the image based on a size of cache memory included in the information processing device.

7. The information processing method according to claim 3,
wherein the execution of trace processing includes
generation of the image as a heatmap that changes in luminance according to number of times of instructions executed for an address of main memory included in the information processing device.

8. The information processing method according to claim 1,
wherein the optimization includes
optimizing the layout address for each system or each mode in which the executable body is executed.

9. A program causing a computer to implement
performing optimization of a layout address of a subroutine in an executable body including a plurality of subroutines, based on a learning result obtained by machine learning.

10. A learning method to be executed by a learning device, the learning method comprising:
executing a link of a plurality of execution bodies, each of the executable bodies including a plurality of subroutines, the execution of the link performed while optionally changing a layout address of the subroutine in the executable body; and
executing each of the plurality of execution bodies generated by executing the link, generating a pair of an image and an evaluation score for the image, the image having been obtained by imaging the layout address based on number of times of executions on the layout address at a time of execution, and performing machine learning using a plurality of the pairs as a dataset.
